(19) United States
(12) Patent Application Publication
(10) Pub. No.: US 2013/0167638 A1
(43) Pub. Date: Jul. 4, 2013

(54) GYRO SENSOR DRIVING CIRCUIT AND METHOD FOR DRIVING GYRO SENSOR

(71) Applicant: SAMSUNG ELECTRO-MECHANICS CO., LTD., Gyeonggi-do (KR)

(72) Inventors: Byoung Won Hwang, Gyeonggi-do (KR); Kyung Rin Kim, Gyeonggi-do (KR); Chang Hyun Kim, Gyeonggi-do (KR)

(73) Assignee: SAMSUNG ELECTRO-MECHANICS CO., LTD., Gyeonggi-do (KR)

(21) Appl. No.: 13/723,166

(22) Filed: Dec. 20, 2012

(30) Foreign Application Priority Data
Dec. 30, 2011 (KR) 10-2011-0146879

(51) Int. Cl. G01C 19/56

(52) U.S. Cl. CPC G01C 19/56
USPC 73/504.12

(57) ABSTRACT

Disclosed herein are a gyro sensor driving circuit and a method for driving a gyro sensor. The gyro sensor driving circuit includes: a driving unit applying a driving signal to a gyro sensor according to a control; a stabilization detection unit determining whether or not driving of the gyro sensor is stabilized and generating a driving stabilization signal; and a timing controller controlling termination of an active section of the driving unit upon receiving the driving stabilization signal from the stabilization detection unit.

### CROSS REFERENCE(S) TO RELATED APPLICATIONS

This application claims the benefit under 35 U.S.C. Section 119 of Korean Patent Application Serial No. 10-2011-0146879, entitled “Gyro Sensor Driving Circuit and Method for Driving Gyro Sensor” filed on Dec. 30, 2011, which is hereby incorporated by reference in its entirety into this application.

### BACKGROUND OF THE INVENTION

1. Technical Field

The present invention relates to a gyro sensor driving circuit and a method for driving a gyro sensor. More particularly, the present invention relates to a gyro sensor driving circuit in which an active section is controlled according to stability of driving of a gyro sensor, and a method for driving a gyro sensor.

2. Description of the Related Art

A gyro sensor, which senses an angular velocity, is commonly used to control the position of aircraft, rockets, robots, and the like, correct hand shaking (shakiness or vibration) of cameras, binoculars, and the like, or commonly employed in a system for preventing sliding or rotation of a vehicle, navigation device, and the like, and recently, it is also mounted in smart phones. Namely, a gyro sensor is highly utilized.

There are several types of gyro sensors: a rotary type gyro sensor, a vibration type gyro sensor, a fluid type gyro sensor, an optical gyro sensor, and the like. Currently, the vibration type gyro sensor is commonly used in mobile products. The vibration type sensor may be divided into two types: One is a piezoelectric vibration type gyro sensor and the other is a capacitive vibration type gyro sensor. Currently used vibration type gyro sensors mostly have a capacitive comb structure, but sometimes, the piezoelectric type is also utilized.

The vibration type gyro sensor may be able to detect the size of an angular velocity by Coriolis force. Here, Coriolis force has a relationship as expressed by a formula shown below:

F=2mVΩ

Here, F is Coriolis force, m is mass, V is velocity, and, Ω is an angular velocity.

The angular velocity Ω=2mV/F, so when a constant speed V is given to an object, the angular velocity Ω can be obtained by measuring Coriolis force F. Here, F, V, Ω are vectors in directions perpendicular to each other, so, in order to obtain Ω in a z direction, V is given to in an x direction and F in a y direction is measured.

For each application for detecting an angular velocity, various sampling rates are required and, at the same time, smaller power consumption is required.

In the related art, a mass of a gyro sensor is resonated by applying a driving signal, and after a driving deflection or resonation is stabilized, the gyro sensor is triggered by a sampling start signal generated according to a sampling time to perform sensing. This related art method is illustrated in FIG. 8.

Namely, in the related art, a driving circuit of the gyro sensor is constantly operated regardless of a sampling rate, and accordingly, a great amount of power is consumed constantly without a change.

### SUMMARY OF THE INVENTION

An object of the present invention is to provide a technique for effectively reducing power consumption according to a sample rate in driving a gyro sensor.

According to an exemplary embodiment of the present invention, there is provided a gyro sensor driving circuit including: a driving unit applying a driving signal to a gyro sensor according to a control; a stabilization detection unit determining whether or not driving of the gyro sensor is stabilized and generating a driving stabilization signal; and a timing controller controlling termination of an active section of the driving unit upon receiving the driving stabilization signal from the stabilization detection unit.

The timing controller may generate a sampling start signal upon receiving a parameter regarding a sampling rate, and the driving unit may be activated according to the sampling start signal as a trigger signal to generate the driving signal.

The gyro sensor driving circuit may further include: a sensing unit sensing an electrode of the gyro sensor, processing the sensed sensor output signal, and outputting the same, wherein the sensing unit may start an active section according to the sampling start signal as a trigger signal, and the active section may be terminated under the control of the timing controller.

The stabilization detection unit may start the active section according to the sampling start signal as a trigger signal, and the active section may be terminated under the control of the timing controller according to providing of the driving stabilization signal to the timing controller.

The stabilization detection unit may determine whether or not driving of the gyro sensor is stabilized by comparing the output signal from the sensing unit and a reference signal.

The sensing unit may sense a driving electrode of the gyro sensor, and the stabilization detection unit may determine whether or not driving of the gyro sensor is stabilized upon sensing a change in the driving signal in the driving electrode sensed by the sensing unit.

The gyro sensor may be a piezoelectric or capacitive vibration type gyro sensor.

According to another exemplary embodiment of the present invention, there is provided a method for driving a gyro sensor, including: applying a driving signal to a gyro sensor under the control of a timing controller; determining, by a stabilization detection unit, whether or not driving of the gyro sensor is stabilized according to the application of the driving signal, and generating a driving stabilization signal; and controlling, by the timing controller, to terminate the application of the driving signal upon receiving the driving stabilization signal.

In the applying, the timing controller may generate a sampling start signal upon receiving a parameter regarding a sampling rate, and the driving signal may be applied according to the sampling start signal as a trigger signal.

The method may further include: initiating an active section of a sensing unit according to the sampling start signal generated in the applying as a trigger signal, sensing, by the sensing unit, an electrode of the gyro sensor, processing the sensed sensor output signal, and outputting the same, and in the controlling, the active section of the sensing unit may be terminated under the control of the timing controller according to reception of the driving stabilization signal.

An active section of the stabilization detection unit may be initiated according to the sampling start signal generated in the applying as a trigger signal, and in the controlling, the active section of the stabilization detection unit may be terminated under the control of the timing controller as the timing controller receives the driving stabilization signal.

In the determining, the stabilization detection unit may determine whether or not driving of the gyro sensor is stabilized by comparing the output signal output in the applying and a reference signal.

In the applying, a driving electrode of the gyro sensor may be sensed, and in the determining, the stabilization detection unit may sense a change in the driving signal in the sensed driving electrode to determine whether or not driving of the gyro sensor is stabilized.

The gyro sensor may be a piezoelectric or capacitive vibration type gyro sensor.

### BRIEF DESCRIPTION OF THE DRAWINGS

FIG. 1 is a schematic block diagram of a gyro sensor driving circuit according to an exemplary embodiment of the present invention;

FIG. 2 is a schematic block diagram of a gyro sensor driving circuit according to another exemplary embodiment of the present invention;

FIG. 3 is a graph schematically showing an operation of elements of the gyro sensor driving circuit according to an exemplary embodiment of the present invention;

FIG. 4 is a flow chart illustrating a method for driving a gyro sensor according to an exemplary embodiment of the present invention;

FIG. 5 is a flow chart illustrating a method for driving a gyro sensor according to another exemplary embodiment of the present invention;

FIGS. 6A and 6B are flow charts illustrating a portion of the method for driving a gyro sensor according to another exemplary embodiment of the present invention;

FIG. 7 is a flow chart illustrating a portion of the method for driving a gyro sensor according to another exemplary embodiment of the present invention; and

FIG. 8 is a graph schematically showing a driving operation of a related art gyro sensor.

### DESCRIPTION OF THE PREFERRED EMBODIMENTS

Exemplary embodiments of the present invention for accomplishing the above-mentioned objects will be described with reference to the accompanying drawings. In the description, the same reference numerals will be used to describe the same components of which detailed description will be omitted in order to allow those skilled in the art to understand the present invention.

In the specification, it will be understood that unless a term such as ‘directly’ is not used in a connection, coupling, or disposition relationship between one component and another component, one component may be ‘directly connected to’, ‘directly coupled to’ or ‘directly disposed to’ another element or be connected to, coupled to, or disposed to another element, having the other element intervening therebetween.

Although a singular form is used in the present description, it may include a plural form as long as it is opposite to the concept of the present invention and is not contradictory in view of interpretation or is used as clearly different meaning. It should be understood that “include”, “have”, “comprise”, “be configured to include”, and the like, used in the present description do not exclude presence or addition of one or more other characteristic, component, or a combination thereof.

First, a gyro sensor driving circuit according to a first embodiment of the present invention will be described in detail. Here, reference numerals not shown in referred drawings may be reference numerals denoting the same configuration illustrated in a different drawing.

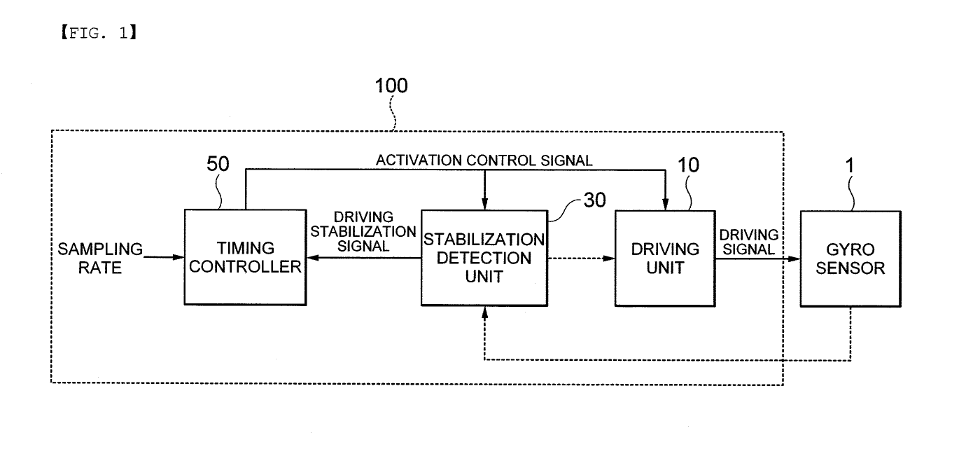

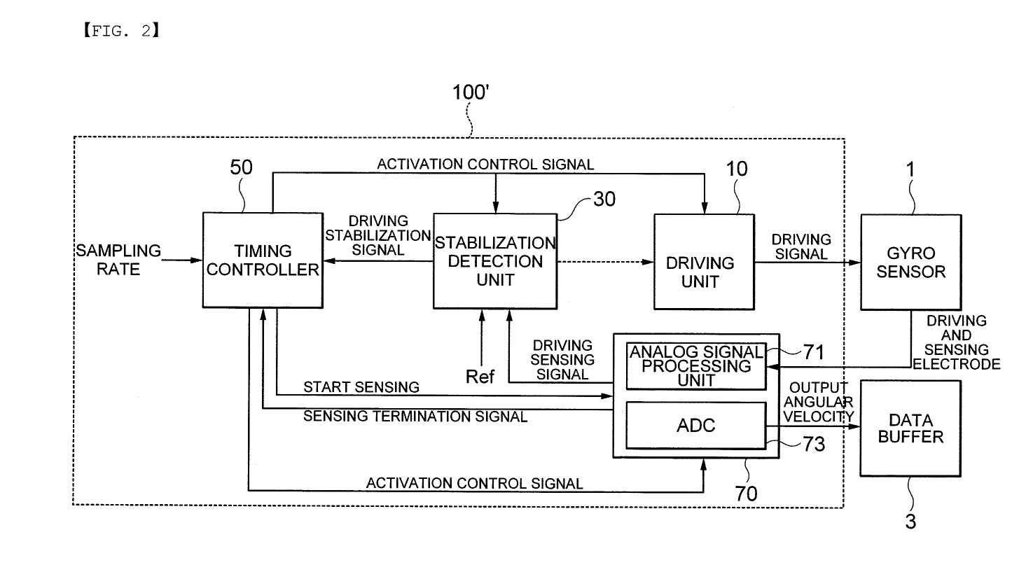

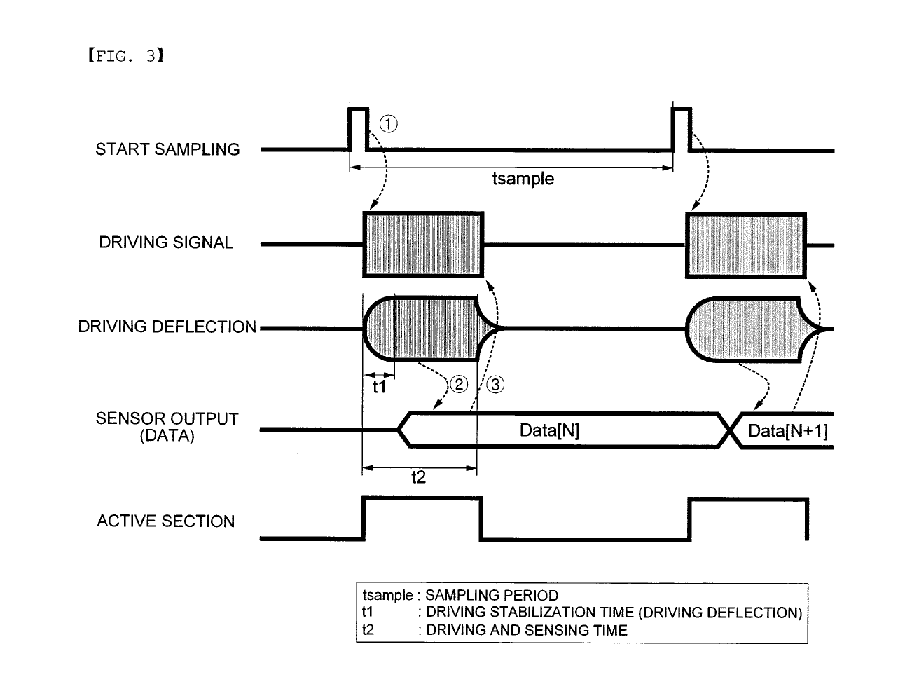

FIG. 1 is a schematic block diagram of a gyro sensor driving circuit according to an exemplary embodiment of the present invention. FIG. 2 is a schematic block diagram of a gyro sensor driving circuit according to another exemplary embodiment of the present invention. FIG. 3 is a graph schematically showing an operation of elements of the gyro sensor driving circuit according to an exemplary embodiment of the present invention.

With reference to FIGS. 1 and 2, embodiments of gyro sensor driving circuits 100 and 100′ will be described.

First, with reference to FIG. 1, the gyro sensor driving circuit 100 may include a driving unit 10, a stabilization detection unit 30, and a timing controller 50.

As an example, the gyro sensor 1 may be a piezoelectric or capacitive vibration type gyro sensor.

The elements of the gyro sensor driving circuit 100 will be described in detail with reference to FIG. 1,

As shown in FIG. 1, the driving unit 10 applies a driving signal to the gyro sensor 1 under the control of the timing controller 50. For instance, the driving signal may be a signal obtained by phase-converting an output signal of the gyro sensor 1 and converting the phase-converted output signal into pulse waves.

With reference to FIG. 3, in an example, the driving unit 10 may be activated according to a sampling start signal generated by the timing controller 50, as a trigger signal. The driving unit 10 may be activated according to the sampling start signal to generate a driving signal.

The stabilization detection unit 30 in FIG. 1 will be described. The stabilization detection unit 30 determines whether or not driving of the gyro sensor 1 is stabilized, and when the driving of the gyro sensor 1 is stabilized according to the determination result, the stabilization detection unit 30 generates a driving stabilization signal. Here, the driving stabilization signal is provided to the timing controller 50.

According to the present embodiment, in case in which an active section is varied according to driving stabilization by using the stabilization detection unit 30, the driving of the gyro sensor 1 can be effectively controlled regardless of deviation in the gyro sensors and an effect of reducing power can be maximized, in comparison to a case in which the active section is simply fixed.

Also, with reference to FIGS. 1 and 3, in an example, when the timing controller 50 generates a sampling start signal, the stabilization detection unit 30 may initiate the active section according to the sampling start signal as a trigger signal. The active section of the stabilization detection unit 30 is controlled by an activation control signal for controlling the active section in FIG. 3.

When the active section of the stabilization detection unit 30 is initiated according to the sampling start signal, the stabilization detection unit 30 may determine whether or not the driving of the gyro sensor 1 is stabilized, and provide a driving stabilization signal to the timing controller 50. Then, the timing controller 50 may generate a control signal for terminating the active section according to the driving stabilization signal, and the active section of the stabilization detection unit 30 may be terminated according to the active section termination control signal.

With reference to FIGS. 2 and 3, in an example, the stabilization detection unit 30 may determine whether or not driving of the gyro sensor 1 is stabilized by comparing an output signal from the sensing unit 70 and a reference signal. In the sensing unit 70, an analog signal processing unit 71 and an analog-to-digital converter (ADC) 73 process a sensor output signal detected by the gyro sensor 1 and output it as, for example, an angular velocity. At this time, the stabilization detection unit 30 may compare an output signal output from the ADC 73 of the sensing unit 70 and the reference signal to determine whether or not driving of the gyro sensor 1 is stabilized. For instance, the stabilization detection unit 30 may determine whether or not driving of the gyro sensor 1 is stabilized by using an automatic gain control (AGC) with respect to the output signal output from the ADC 73.

In FIG. 3, when the sensor output is stabilized after the lapse of a driving stabilization time t1, the stabilization detection unit 30 in FIG. 2 provides a driving stabilization signal to the timing controller 50. For instance, the stabilization detection unit 30 may control and detect driving stabilization by using the AGC. As the AGC, proportional integral differential (PID) control, i.e., closed-loop control, is used to make a driving strength uniform. For the PID control, a target value (reference) is compared with an output value (y) to calculate an error (e), and a manipulation amount (u) is changed by using proportional integral differential items of the error value to make the error 0, and in this case, when the error is 0, it may be determined that driving is stabilized.

In another example, the stabilization detection unit 30 may determine whether or not the gyro sensor 1 is stabilized based on a change in a driving electrode of the gyro sensor 1 sensed by the sensing unit 70, rather than by the output signal from the sensing unit 70. For instance, a high or low section of a driving signal is counted by using an internal clock to obtain a change and driving stabilization may be determined based on the corresponding change. Namely, the sensing unit may sense a change in a driving signal in the driving electrode of the gyro sensor 1, and when there is no substantial change in the sensed driving signal, the stabilization detection unit 30 may determine that driving of the gyro sensor 1 is stabilized. This is because, the driving signal applied to the driving electrode of the gyro sensor 1 is a signal which is fed back through phase conversion, or the like, after an output signal from the gyro sensor 1 is received, so when driving of the gyro sensor 1 is stabilized, there is no substantial change in the feedback driving signal.

Continuously, the timing controller 50 in FIG. 1 will be described. The timing controller 50 controls termination of the active section of the driving unit 10 upon receiving the driving stabilization signal from the stabilization detection unit 30. Namely, when driving of the gyro sensor 1 is stabilized, activation of the driving unit 10 is terminated, rather than leaving the driving unit 10 in an active state, to effectively reduce power consumption.

Also, with reference to FIG. 2, in an example, upon receiving the driving stabilization signal, the timing controller 50 may also control termination of the active sections of the stabilization detection unit 30 and/or the sensing unit 70, as well as that of the driving unit 10.

In addition, with reference to FIG. 2, in an example, after receiving a sensing termination signal from the sensing unit 70, the timing controller 50 may control termination of the active sections of the driving unit 10, the stabilization detection unit 30, and/or the sensing unit 70. For instance, after receiving the driving stabilization signal from the stabilization detection unit 30 and the sensing termination signal from the sensing unit 70, the timing controller 50 may control termination of the active section.

This will be described in more detail with reference to FIGS. 1 and 3. In an example, the timing controller 50 may receive a parameter regarding a sampling rate and generate a sampling start signal. With reference to FIG. 1, the timing controller 50 receives a parameter regarding a sampling rate. In this case, with reference to FIG. 3, when the timing controller 50 receives a parameter regarding a sampling rate, e.g., a sampling period, the timing controller 50 generates a sampling start signal according to the sampling rate. For instance, the sampling start signal may be a periodic pulse signal.

With reference to FIG. 3, as indicated by the mark, the sampling start signal may be a control signal or a trigger signal for activating the driving unit 10. In FIG. 3, the sampling start signal is an activation control signal for initiating an active section. Here, the graph showing the active section illustrated in FIG. 3 shows an active and inert period according to the activation control signal. With reference to FIG. 1, the activation control signal for controlling the active section may control the activity (or activation) of the driving unit 10. Also, with reference to FIG. 2, in an example, the activation control signal may control activation and activation termination of the stabilization detection unit 30 and/or the sensing unit 70 as well as that of the driving unit 10.

With reference to FIG. 3, the driving unit 10 triggers the sampling start signal generated at every sampling time to generate a driving signal to resonate mass of the gyro sensor 1. The driving unit 10 monitors resonance, and when the resonance, namely, driving, of the gyro sensor 1 is stabilized, the driving unit 10 finally outputs a sensor output (data).

Accordingly, the elements of the gyro sensor driving circuits 100 and 100′ in FIGS. 1 and 2 can operate only during the active section without consuming a great amount of power otherwise due to permanent activation, and as a result, power consumption can be effectively reduced. In this case, power consumption may be proportional to t2/tsample. Here, t2 is a driving stabilization time, and tsample is a sampling period.

Also, in an example, the sampling start signal of the timing controller 50 may be a control signal or a trigger signal for activating the stabilization detection unit 30. Namely, with reference to FIG. 3, the active section is initiated according to the sampling start signal, and here, the activation control signal for controlling the active section may control activity of the stabilization detection unit 30 as well as that of the driving unit 10.

This will be further described with reference to FIG. 3. When the driving unit 10 is driven during the active section initiated by the activation control signal according to the sampling start signal, after the driving stabilization time has lapsed, a driving output, i.e., a sensor output, of the gyro sensor 1 is stabilized. With reference to the mark in FIG. 3, the sensor output is stabilized after the lapse of the driving stabilization time t1. Here, when the driving output, i.e., the sensor output, from the gyro sensor 1 is stabilized, the stabilization detection unit 30 of FIG. 1 provides a driving stabilization signal to the timing controller 50.

With reference to FIG. 3, after the driving output, i.e., the sensor output, from the gyro sensor 1 is stabilized, the active section is terminated. Here, the mark indicates that termination of the driving signal is controlled after the driving output, i.e., the sensor output, from the gyro sensor 1 is stabilized. Namely, the timing controller 50 may generate a control signal for terminating the active section according to the driving stabilization signal. Here, the control signal for terminating the active section refers to changing an activation control signal in a high state into a low activation control signal according to the sampling start signal. With reference to FIG. 3, as the activation control signal is changed into the low active controls signal, the active section is terminated, and accordingly, the activity of the stabilization detection unit 30, as well as that of the driving unit 10, is terminated.

Next, an exemplary embodiment will be described with reference to FIG. 2. With reference to FIG. 2, the gyro sensor driving circuit 100′ includes the sensing unit 70 that senses an electrode of the gyro sensor 1, processes a sensed sensor output signal, and outputs the same. For example, the sensing unit 70 may amplify the sensor output signal output from a sensor electrode of the gyro sensor 1, process the amplified sensor output signal, and output the processed signal. Also, in an example, the sensing unit 70 may sense a driving signal applied to a driving electrode of the gyro sensor 1 to sense a corresponding change. With reference to FIG. 2, for example, the sensing unit 70 may amplify the sensor output signal, process the amplified sensor output signal, and output the processed signal to the outside, and simultaneously or sequentially transmit a sensing termination signal to the timing controller 50.

With reference to FIGS. 2 and 3, the timing controller 50 may provide the activation control signal based on a sampling rate parameter to initiate the active section, and when an output signal is output from the sensing unit 70, e.g., when sensing of the angular velocity is completed, after driving is stabilized, the timing controller 50 turns off the activation control signal to terminate the active section. In this case, the timing controller 50 may receive the sensing termination signal from the sensing unit 70 and then terminate the active sections of the driving unit 10, the stabilization detection unit 30, and/or the sensing unit 70 according to the activation control signal. Sensing is completed by the analog signal processing unit 71 and the ADC 73 of the sensing unit 70. The ADC 73 starts quantization according to a start signal or condition, and when sensing is completed, an end of conversion (EOC) signal, along with digital data, is output. A sensing completion time can be known through the EOC signal.

With reference to FIG. 2, the activation control signal is periodically generated according to the sampling rate. Also, upon receiving the driving stabilization signal (dry stable), the timing controller 50 controls the sensing unit 70 to perform an angular velocity outputting operation, and when the angular velocity is extracted, the timing controller 50 terminates the activation control signal. The angular velocity output sensed by the sensing unit 70 is stored in an external data buffer 3. A raw signal from the gyro sensor 1 has a form in which the angular velocity component is modulated in the driving signal, so the sensing unit 70, e.g., the analog signal processing unit 71, demodulates the output signal from the gyro sensor 1 to extract the angular velocity component, amplifies the extracted angular velocity component, signal-processes, such as filters, the amplified signal, and a final angular velocity signal is output through the ADC 73 of the sensing unit 70.

The sensing unit 70 in FIG. 2 may be operated according to the sampling start signal generated by the timing controller 50, as a trigger signal. In FIG. 3, the sensing unit 70 is activated during the driving and sensing time t2 according to the sampling start signal, and data quantized in the ADC 73 of the sensing unit 70 is stored in the external data buffer 3, or the like. FIG. 3 shows that a continuous sensor output (data) is stored in, for instance, the data buffer 3 or the like.

Also, in another example, the sensing unit 70 may sense the driving electrode of the gyro sensor 1. At this time, the stabilization detection unit 30 may sense a change in a driving signal from the driving electrode sensed by the sensing unit 70 to determine whether or not driving of the gyro sensor 1 is stabilized.

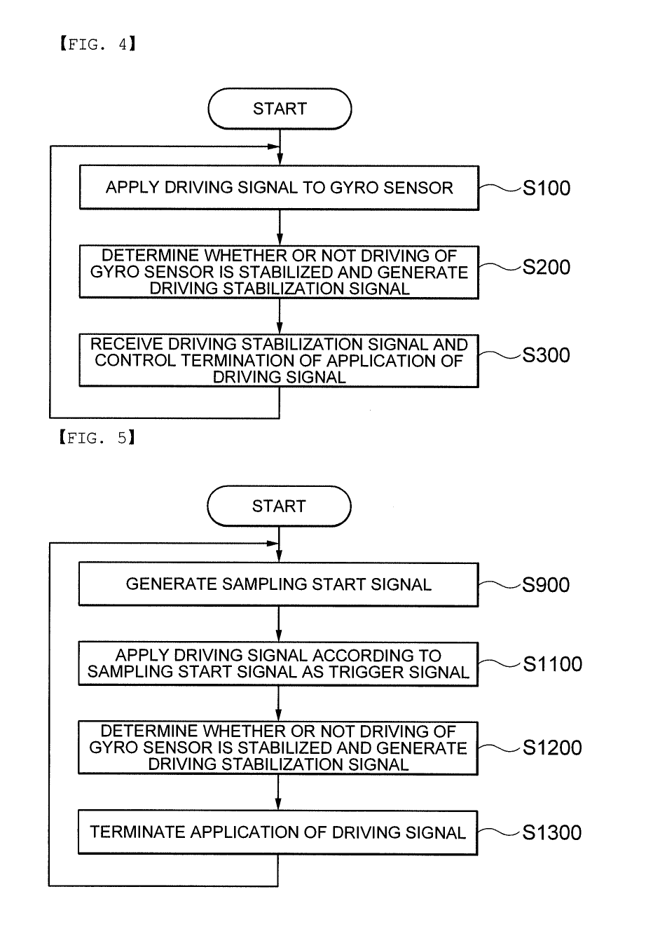

Hereinafter, a method for driving a gyro sensor according to a second embodiment of the present invention will be described in detail. In describing the present embodiments, the gyro sensor driving circuit according to the foregoing first embodiments and FIGS. 1 through 3, as well as FIGS. 4 through 7, will be referred to, and accordingly, repeated descriptions may be omitted.

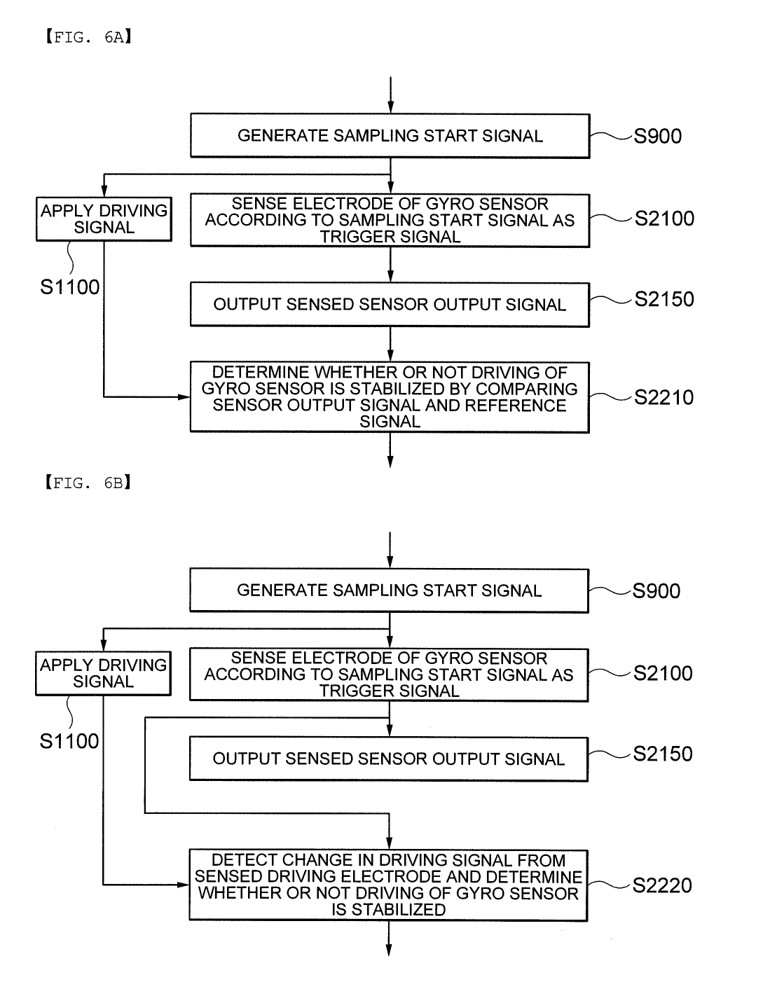

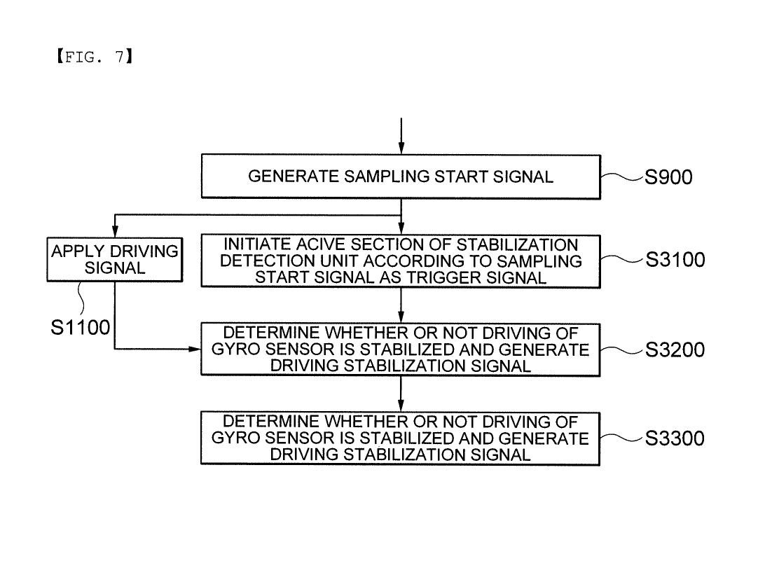

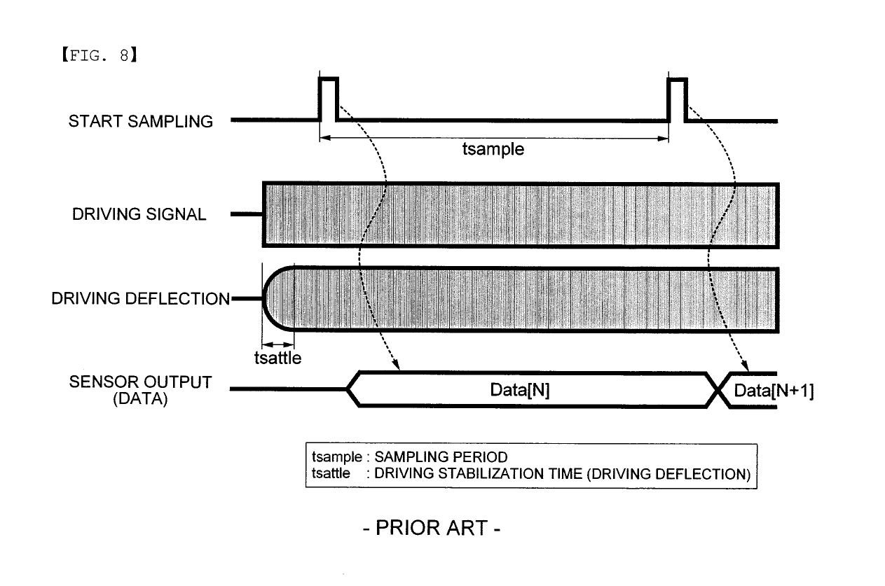

FIG. 4 is a flow chart illustrating a method for driving a gyro sensor according to an exemplary embodiment of the present invention. FIG. 5 is a flow chart illustrating a method for driving a gyro sensor according to another exemplary embodiment of the present invention. FIGS. 6A and 6B are flow charts illustrating a portion of the method for driving a gyro sensor according to another exemplary embodiment of the present invention. FIG. 7 is a flow chart illustrating a portion of the method for driving a gyro sensor according to another exemplary embodiment of the present invention.

A method for driving a gyro sensor will be described with reference to FIGS. 4 through 7. Here, in an example, the gyro sensor 1 may be a piezoelectric or capacitive vibration type gyro sensor.

With reference to FIG. 4, a method for driving a gyro sensor may include applying, determining and controlling (S100 to S300) as follows.

With reference to FIG. 4, in the applying (S100), a driving signal is applied to the gyro sensor 1 under the control of the timing controller 50.

In detail, with reference to FIG. 5, in an example, in the foregoing the applying, the timing controller 50 may receive a parameter regarding a sampling rate to generate a sampling start signal (S900), and a driving signal may be applied according to the sampling start signal as a trigger signal (S1100).

Also, with reference to FIGS. 6A and 6B, in the foregoing the applying, the timing controller 50 generates a sampling start signal (S900), and the sensing unit 70 senses an electrode of the gyro sensor 1 according to the generated sampling start signal as a trigger signal (S2100). In this case, the sensing unit 70 may sense a sensor electrode of the gyro sensor 1 to sense a sensor output signal.

Also, although not shown in FIGS. 6A and 6B, in the foregoing the controlling, an active section of the sensing unit 70 may be terminated under the control of the timing controller 50 according to reception of a driving stabilization signal. Here, in an example, the timing controller 50 may terminate the active sections of the driving unit 10, the stabilization detection unit 30, and/or the sensing unit 70 after receiving a sensing termination signal from the sensing unit 70.

Alternatively, in another example, with reference to FIG. 6B, in the foregoing the applying, the sensing unit 70 may also sense a driving electrode of the gyro sensor 1. Namely, the sensing unit 70 may sense a change in a driving signal applied to the driving electrode of the gyro sensor 1.

Continuously, with reference to FIGS. 6A and 6B, the sensing unit 70 processes the sensed sensor output signal by using, for instance, the analog signal processing unit 71 and/or the ADC 73 and outputs a corresponding sensor output signal (S2150). Here, the sensor output signal may be an output signal from the sensor electrode of the gyro sensor 1.

In another example with reference to FIG. 7, in the foregoing the applying, the timing controller 50 generates the sampling start signal (S900) and initiates the active section of the stabilization detection unit 30 according to the generated sampling start signal as a trigger signal (S3100).

With reference back to FIG. 4, in the determining (S200), the stabilization detection unit 30 determines whether or not driving of the gyro sensor 1 is stabilized according to an application of a driving signal, and generates a driving stabilization signal.

Here, in an example with reference to FIG. 6A, in the foregoing the determining, the stabilization detection unit 30 may determine whether or not driving of the gyro sensor 1 is stabilized by comparing the output signal and a reference signal (S2210). Here, the output signal is a signal output to, for instance, the external data buffer 3 after the sensing unit 70 amplifies and processes the sensor output signal from the gyro sensor 1. For instance, the output signal may be an angular velocity output signal.

Also, in another example with reference to FIG. 6B, unlike the case of FIG. 6A, in the foregoing (b) step, the stabilization detection unit 30 may determine that driving of the gyro sensor 1 is stabilized upon sensing a change in the driving signal from the sensed driving electrode (S2230).

Continuously, an exemplary embodiment of a method for driving a gyro sensor will be described with reference to FIG. 4.

In the controlling (S300) of FIG. 4, the timing controller 50 may provide control to terminate application of the driving signal upon receiving the driving stabilization signal. In this case, as activity of the driving unit 10 is terminated under the control of the timing controller 50, application of the driving signal is terminated. This is the same also in FIG. 5 (S1300).

Also, in another example with reference to FIG. 7, when the active section of the stabilization detection unit 30 is initiated according to the sampling start signal as a trigger signal (S3100), the stabilization detection unit 30 determines whether or not driving of the gyro sensor 1 is stabilized according to an application of a driving signal, and generates a driving stabilization signal (S3200), and in the foregoing the controlling, as the timing controller 50 receives the driving stabilization signal, the active section of the stabilization detection unit 30 may be terminated under the controller of the timing controller 50 (S3300).

According to an exemplary embodiment of the present invention, in driving the gyro sensor, power consumption can be effectively reduced according to a sampling rate.

According to an exemplary embodiment of the present invention, power consumption can be minimized according to a sampling rate by dynamically controlling an ON/OFF operation of the elements of the gyro sensor driving circuit.

Here, as the sampling rate is reduced or as a sampling period time is large, a reduction in power consumption can be maximized.

In addition, according to an exemplary embodiment of the present invention, since the stabilization detection unit monitors driving stabilization of the gyro sensor, the gyro sensor can be effectively controlled regardless of deviation in the gyro sensors and the effect of reducing power can be maximized.

It is obvious that various effects directly stated according to various exemplary embodiment of the present invention may be derived by those skilled in the art from various configurations according to the exemplary embodiments of the present invention.

The accompanying drawings and the above-mentioned exemplary embodiments have been illustratively provided in order to assist in understanding of those skilled in the art to which the present invention pertains rather than limiting a scope of the present invention. In addition, exemplary embodiments according to a combination of the above-mentioned configurations may be obviously implemented by those skilled in the art. Therefore, various exemplary embodiments of the present invention may be implemented in modified forms without departing from an essential feature of the present invention. In addition, a scope of the present invention should be interpreted according to claims and includes various modifications, alterations, and equivalences made by those skilled in the art.

What is claimed is:

1. A gyro sensor driving circuit comprising:
a driving unit applying a driving signal to a gyro sensor according to a control;
a stabilization detection unit determining whether or not driving of the gyro sensor is stabilized and generating a driving stabilization signal; and
a timing controller controlling termination of an active section of the driving unit upon receiving the driving stabilization signal from the stabilization detection unit.

2. The gyro sensor driving circuit according to claim 1, wherein the timing controller generates a sampling start signal upon receiving a parameter regarding a sampling rate, and the driving unit is activated according to the sampling start signal as a trigger signal to generate the driving signal.

3. The gyro sensor driving circuit according to claim 2, further comprising:
a sensing unit sensing an electrode of the gyro sensor, processing the sensed sensor output signal, and outputting the same,
wherein the sensing unit starts an active section according to the sampling start signal as a trigger signal, and the active section is terminated under the control of the timing controller.

4. The gyro sensor driving circuit according to claim 2, wherein the stabilization detection unit starts the active section according to the sampling start signal as a trigger signal, and the active section is terminated under the control of the timing controller according to providing the driving stabilization signal to the timing controller.

5. The gyro sensor driving circuit according to claim 3, wherein the stabilization detection unit determines whether or not driving of the gyro sensor is stabilized by comparing the output signal from the sensing unit and a reference signal.

6. The gyro sensor driving circuit according to claim 3, wherein the sensing unit senses a driving electrode of the gyro sensor, and the stabilization detection unit determines whether or not driving of the gyro sensor is stabilized upon sensing a change in the driving signal in the driving electrode sensed by the sensing unit.

7. The gyro sensor driving circuit according to claim 1, wherein the gyro sensor is a piezoelectric or capacitive vibration type gyro sensor.

8. The gyro sensor driving circuit according to claim 2, wherein the gyro sensor is a piezoelectric or capacitive vibration type gyro sensor.

9. The gyro sensor driving circuit according to claim 3, wherein the gyro sensor is a piezoelectric or capacitive vibration type gyro sensor.

10. The gyro sensor driving circuit according to claim 4, wherein the gyro sensor is a piezoelectric or capacitive vibration type gyro sensor.

11. A method for driving a gyro sensor, the method comprising:
applying a driving signal to a gyro sensor under the control of a timing controller;
determining, by a stabilization detection unit, whether or not driving of the gyro sensor is stabilized according to the application of the driving signal, and generating a driving stabilization signal; and
controlling, by the timing controller, to terminate the application of the driving signal upon receiving the driving stabilization signal.

12. The method according to claim 11, wherein, in the applying, the timing controller generates a sampling start signal upon receiving a parameter regarding a sampling rate, and the driving signal is applied according to the sampling start signal as a trigger signal.

13. The method according to claim 12, further comprising:
initiating an active section of a sensing unit according to the sampling start signal generated in the applying as a trigger signal, sensing, by the sensing unit, an electrode of the gyro sensor, processing the sensed sensor output signal, and outputting the same, and
in the controlling, the active section of the sensing unit is terminated under the control of the timing controller according to reception of the driving stabilization signal.

14. The method according to claim 12, wherein an active section of the stabilization detection unit is initiated according to the sampling start signal generated in the applying as a trigger signal, and
in the controlling, the active section of the stabilization detection unit is terminated under the control of the timing controller as the timing controller receives the driving stabilization signal.

15. The method according to claim 13, wherein, in the determining, the stabilization detection unit determines whether or not driving of the gyro sensor is stabilized by comparing the output signal output in the applying and a reference signal.

16. The method according to claim 13, wherein, in the applying, a driving electrode of the gyro sensor is sensed, and in the determining, the stabilization detection unit senses a change in the driving signal in the sensed driving electrode to determine whether or not driving of the gyro sensor is stabilized.

17. The method according to claim 11, wherein the gyro sensor is a piezoelectric or capacitive vibration type gyro sensor.

18. The method according to claim 12, wherein the gyro sensor is a piezoelectric or capacitive vibration type gyro sensor.

19. The method according to claim 13, wherein the gyro sensor is a piezoelectric or capacitive vibration type gyro sensor.

20. The method according to claim 14, wherein the gyro sensor is a piezoelectric or capacitive vibration type gyro sensor.
